(19) United States
(12) Patent Application Publication
(10) Pub. No.: US 2017/0039884 A1
(43) Pub. Date: Feb. 9, 2017

(54) FUNCTIONAL FOOD FORMULA ANALYSIS SYSTEM FOR PERSONALIZED BODY WEIGHT MANAGEMENT

(71) Applicant: UNION APPLIED GENE INC., TAIPEI CITY (TW)

(72) Inventor: Hung-Wei SHU, TAIPEI CITY (TW)

(21) Appl. No.: 14/816,078

(22) Filed: Aug. 3, 2015

(51) Int. Cl. G09B 19/00; G09B 5/02

(52) U.S. Cl. CPC G09B 19/0092; G09B 5/02

(57) ABSTRACT

A functional food formula analysis system for personalized body weight management includes a user input unit, a body constitution analysis data unit, a functional food data unit, an analysis server unit, and an analysis result storage unit. The analysis server unit is connected to the other units and is configured for retrieving personal data, personal genetic data, and obesity-associated body constitution data and performing data comparison, exchange, and integration on those data in order to output a personalized functional food formula report to be stored in the analysis result storage unit. The personalized functional food formula report not only informs the user of suitable functional food, but also provides appropriately prepared functional food ingredient type data and functional food ingredient quantity data so that the user can carry out precise body weight control to achieve the ideal body weight.

### BACKGROUND OF THE INVENTION

Field of the Invention

The present invention relates to a body weight management system and more particularly to a functional food formula analysis system for personalized body weight management.

Related Prior Art

Body weight control is associated not only with a person's habits of life, but also with body metabolism, which is regulated by genes. Improper body weight management may lead to obesity or emaciation, in the former case of which excessive fat tends to hinder blood circulation and increase the susceptibility to chronic diseases. However, the effects of known body weight control methods, such as the use of over-the-counter medicines, health-promoting food, and/or folk remedies that are anti-obesity, vary from one person to another, not to mention that the applicability of those methods depends on the user's body constitution.

Nowadays, the integration of biomedicine and data technologies has made possible a systematic evaluation of a person's body constitution and given rise to personalized products that are designed for body weight management and for different body constitutions. For instance, Taiwan Patent No. M474214 discloses an “OBESITY GENE TESTING AND ASSESSMENT SYSTEM”, in which a server collects personal data and genetic test data in order to obtain a possibility of obesity from a genetic risk analysis database, assess and analyze the possibility in conjunction with the personal data, and automatically generate the corresponding recommendation data, allowing the user to easily obtain the desired data and a solution to obesity.

In addition, Taiwan Patent No. 1376636, entitled “CUSTOMISED NUTRITIONAL FOOD AND BEVERAGE DISPENSING SYSTEM”, discloses a device for dispensing customized servings of nutrition, wherein a controller is provided for storing an inventory of nutritious ingredients, their compositions and properties, and user profile data. The system is programmed to consider the inventory of ingredients and the user's general health conditions, present the user with a selected serving, and then prepare and dispense the selected serving of nutritious, health-promoting food. While the systems disclosed in the afore-cited patents can offer users recommendation data based on genetic test data or the like, they do not provide substantial guidance to functional food; as a result, their effects on body weight control are limited.

### SUMMARY

The present invention provides a functional food formula analysis system for personalized body weight management. The major objective of the present invention is to generate a personalized functional food formula report via an analysis server unit (which is connected to a user input unit, a body constitution analysis data unit, and a functional food data unit) by performing data comparison, exchange, and integration on the user's obesity-associated body constitution data and a personalized functional food formula. The personalized functional food formula report enables precise body weight management so that the user can achieve the ideal body weight.

To attain the foregoing objective, a functional food formula analysis system for personalized body weight management is provided which includes a user input unit, a body constitution analysis data unit, a functional food data unit, an analysis server unit, and an analysis result storage unit, wherein: the user input unit is connected to the analysis server unit and is configured for inputting at least one entry of personal data or personal genetic data; the body constitution analysis data unit is connected to the analysis server unit and is configured for analyzing the personal data or the personal genetic data so as to obtain the user's obesity-associated body constitution data, and for sending the obesity-associated body constitution data to the analysis server unit; the functional food data unit is connected to the analysis server unit and is configured for analyzing the personal data and the obesity-associated body constitution data so as to obtain a personalized functional food formula, and for sending the personalized functional food formula to the analysis server unit; the analysis server unit is connected to the user input unit, the body constitution analysis data unit, and the functional food data unit and is configured for retrieving, and performing data comparison, exchange, and integration on, the personal data, the personal genetic data, and the obesity-associated body constitution data, and for outputting a personalized functional food formula report; and the analysis result storage unit is connected to the analysis server unit and is configured for storing the personalized functional food formula report.

Preferably, the personalized functional food formula includes a corresponding formula ingredient and an auxiliary ingredient.

Preferably, the personalized functional food formula report includes personal body constitution data, functional food ingredient type data, and functional food ingredient quantity data.

### BRIEF DESCRIPTION OF THE DRAWINGS

FIG. 1 is a system block diagram of the present invention.

### DETAILED DESCRIPTION

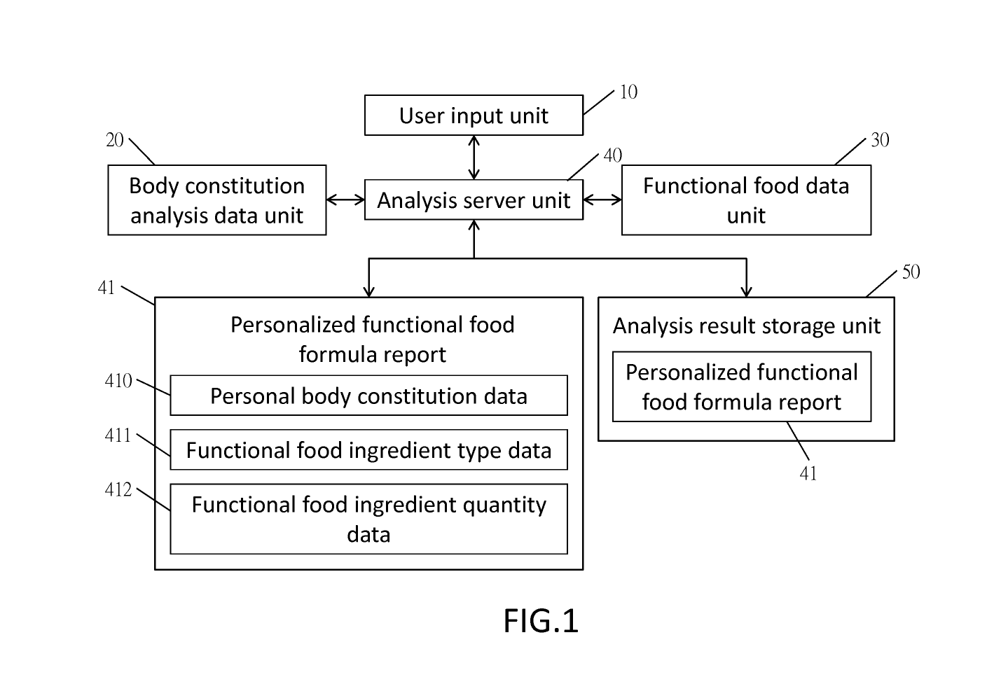

Referring to FIG. 1 and TABLES 1 through 5, the present invention provides a functional food formula analysis system for personalized body weight management, wherein the system includes a user input unit 10, a body constitution analysis data unit 20, a functional food data unit 30, an analysis server unit 40, and an analysis result storage unit 50.

The user input unit 10 is connected to the analysis server unit 40 and can be used to input at least one entry of personal data 100 or personal genetic data 101.

The body constitution analysis data unit 20 is connected to the analysis server unit 40 and is configured to analyze the personal data 100 or the personal genetic data 101, to thereby obtain the user's obesity-associated body constitution data 21, and to send the obesity-associated body constitution data 21 to the analysis server unit 40.

The functional food data unit 30 is connected to the analysis server unit 40 and is configured to analyze the personal data 100 and the obesity-associated body constitution data 21, to thereby obtain a personalized functional food formula 31, and to send the personalized functional food formula 31 to the analysis server unit 40.

The analysis server unit 40 is connected to the user input unit 10, the body constitution analysis data unit 20, and the functional food data unit 30 and is configured to retrieve the personal data 100, the personal genetic data 101, and the obesity-associated body constitution data 21; to perform data comparison, exchange, and integration on those data; and to thereby output a personalized functional food formula report 41.

The analysis result storage unit 50 is connected to the analysis server unit 40 and is configured to store the personalized functional food formula report 41.

A practical example is given below to illustrate the use of the present invention. To begin with, the user logs on to the user input unit 10 in a wired or wireless manner and inputs at least one entry of personal data 100 and personal genetic data 101 through the user input unit 10. As shown in TABLES 1 and 2, the personal data 100 include a name 1000, an identification (ID) card number 1001, a gender 1002, a body height 1003, and a body weight 1004, while the personal genetic data 101 include an ID card number 1010, β2-adrenergic receptor (ADRB2)-based obesity gene data 1011, β3-adrenergic receptor (ADRB3)-based obesity gene data 1012, uncoupling protein (UCP1)-based obesity gene data 1013, and melanocortin-4 receptor(MC4R)-based obesity gene data 1014.

TABLE 1

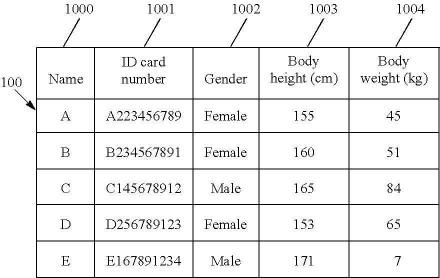

TABLE 2

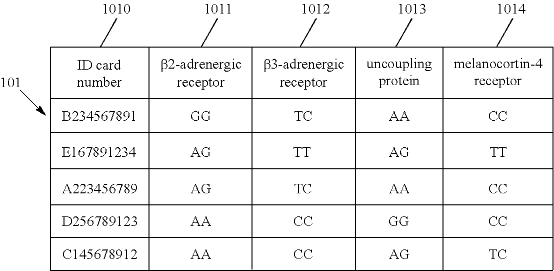

After that, the analysis server unit 40 retrieves the personal data 100 and the personal genetic data 101 from the user input unit 10 and sends those data to the body constitution analysis data unit 20 for data comparison and exchange so as to obtain the user's obesity-associated body constitution data 21. As shown in TABLE 3, the obesity-associated body constitution data 21 include an ID card number 210, a gender 211, an obesity gene 212 (including the β2-adrenergic receptor-encoding gene, the β3-adrenergic receptor-encoding gene, the uncoupling protein-encoding gene, and the melanocortin-4 receptor-encoding gene), a test result 213, and a function rating 214. The function rating 214 is obtained from a weighted aggregation analysis of the gender 211 and the test result 213 and is generally divided into four grades, namely A, B, C, and D, wherein grade A means normal functionality and grades B to D mean increasingly poor functionality.

TABLE 3

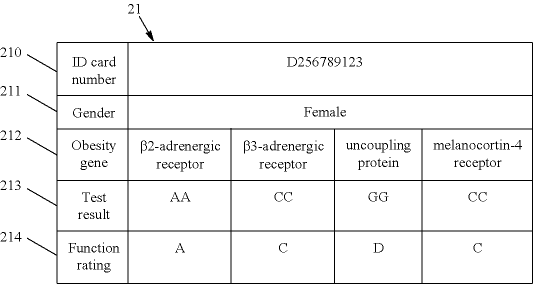

The function of the β2-adrenergic receptor (ADRB2)-encoding gene is related to muscle growth. If the functionality of this gene is lowered, the efficiency of muscle growth will be compromised, resulting in a decrease in basal metabolic rate (BMR, which corresponds to the minimum energy required to maintain the operation of the vital organs of a human body and is an indicator of the metabolic ability of human cells). Once the energy taken into the body cannot be effectively consumed, the excessive energy will be transformed into fats. The function of the β3-adrenergic receptor (ADRB3)-encoding gene is related to the breakdown of fats. If the functionality of this gene is lowered, body fats cannot be broken down or metabolized efficiently and will accumulate instead, causing obesity. The function of the uncoupling protein (UCP1)-encoding gene is related to the burning of fats. If the functionality of this gene is lowered, body fats cannot be burned or metabolized efficiently, and obesity ensues. The function of the melanocortin-4 receptor (MC4R) is related to appetite control. If the functionality of this gene is lowered, one may have problem feeling satiated and therefore keeps on eating. As a result, too much energy is taken into the body on a daily basis and eventually turns into fats that accumulate in the body.

Continued from the paragraph preceding the last, the analysis server unit 40 further retrieves the personal data 100 and the obesity-associated body constitution data 21 and sends them to the functional food data unit 30 for data analysis and computation so as to obtain the personalized functional food formula 31. As shown in TABLE 4, the personalized functional food formula 31 includes formula ingredients 311 corresponding respectively to such obesity genes 310 as the β2-adrenergic receptor-, β3-adrenergic receptor-, uncoupling protein-, and melanocortin-4 receptor-encoding genes. For example, the formula ingredients 311 for one whose obesity gene 310 is the gene encoding the β2-adrenergic receptor (ADRB2) are leucine, isoleucine, valine, vitamin B1, vitamin B2, nicotinic acid, pantothenic acid, vitamin B6, and vitamin B12. The personalized functional food formula 31 also provides auxiliary ingredients 312. While the formula ingredients 311 compensate for functionality disorder caused by the obesity gene, the auxiliary ingredients 312 serve to regulate other physical and mental imbalance attributable to obesity. The efficacy data, effective quantity, and safe range of quantity of all the formula ingredients 311 and auxiliary ingredients 312 comply with applicable laws and regulations of the Ministry of Health and Welfare, making the ingredients suitable for use as the basis on which to prepare personalized functional food.

TABLE 4

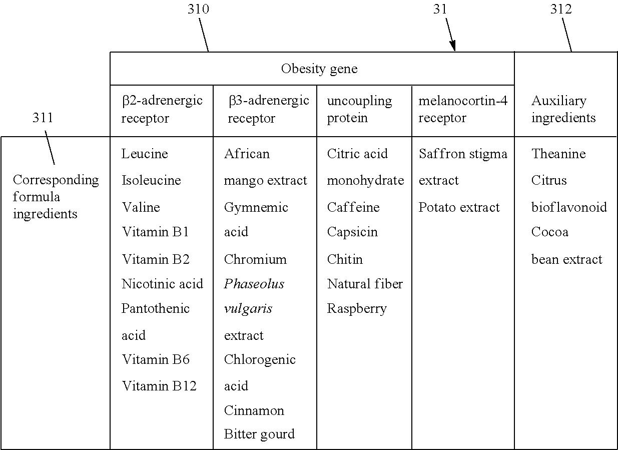

Lastly, the analysis server unit 40 retrieves and performs data integration on the obesity-associated body constitution data 21 and the personalized functional food formula 31, formats the integrated data automatically, and then outputs the personalized functional food formula report 41. As shown in FIG. 1, the personalized functional food formula report 41 includes personal body constitution data 410, functional food ingredient type data 411, and functional food ingredient quantity data 412. TABLE 5 shows the effects of the following functional food formula ingredients: leucine, isoleucine, valine, vitamin B1, vitamin B2, nicotinic acid, pantothenic acid, vitamin B6, vitamin B12, African mango extract, gymnemic acid, chromium, Phaseolus vulgaris extract, chlorogenic acid, cinnamon, bitter gourd, citric acid monohydrate, caffeine, capsicin, chitin, natural fiber, raspberry, saffron stigma extract, potato extract, theanine, citrus bioflavonoid, and cocoa bean extract.

TABLE 5

| Obesity gene | | | | | | | | | |
|---|---|---|---|---|---|---|---|---|---|
| β2-adrenergic receptor | | | | | | | | | |
| Corre- | | β3-adrenergic receptor | | uncoupling protein | | melanocortin-4 receptor | | | |
| sponding | | Corresponding | | Corresponding | | Corresponding | | Auxiliary ingredients | |
| formula | Complete | formula | Complete | formula | Complete | formula | Complete | | Complete |
| ingredients | effects | ingredients | effects | ingredients | effects | ingredients | effects | Ingredients | effects |
| Leucine | Assist in | African | Enhances | Citric acid | Reduces fat | Saffron | Suppresses | Theanine | Helps |
| | protein | mango | fatty acid | monohydrate | synthesis | stigma | appetite | | stabilize |
| | synthesis | extract | oxidation | | Suppresses | extract | Stabilizes | | mood and |
| | and | | Enhances | | appetite | | mood | | reduce |
| | muscle | | utilization | | Increases fat | | | | anxiety |
| | growth | | of glucose | | breakdown | | | | |
| | Preserve | | Increases | | by 50% | | | | |
| | lean body | | satiation | | Reduces | | | | |
| | tissues | | and | | caloric intake | | | | |
| | and help | | suppresses | | by 25% | | | | |
| | increase | | appetite | | | | | | |
| Isoleucine | basal | Gymnemic | Enhances | Caffeine | Increases | Potato | Delays | Citrus | Resists |
| | metabolic | acid | fatty acid | | fatty acid | extract | stomach | bioflavonoid | oxidation |
| | rate | | oxidation | | oxidation | | emptying | | and |
| | | | Enhances | | Increases | | and | | eliminates |
| | | | utilization | | energy | | induces | | free |
| | | | of glucose | | consumption | | satiation to | | radicals |
| | | | Triggers | | Increases | | suppress | | |
| | | | heat | | satiation and | | appetite | | |
| | | | generation | | suppresses | | Reduces | | |
| | | | Increases | | appetite | | food | | |
| | | | satiation | | | | intake by | | |
| | | | and | | | | about 25% | | |
| | | | suppresses | | | | Increases | | |
| | | | appetite | | | | body fat | | |
| | | | | | | | burning | | |
| | | | | | | | about | | |
| | | | | | | | twofold | | |
| Valine | | Chromium | Increases | Capsicin | Increases | | | Cocoa | Resists |
| | | | insulin | | fatty acid | | | bean | oxidation |
| | | | sensitivity | | oxidation | | | extract | and |
| | | | Helps | | Triggers | | | | eliminates |
| | | | reduce | | heat | | | | free radical |
| | | | cholesterol | | generation | | | | Helps |
| | | | and | | Increases | | | | reduce |
| | | | triglyceride | | utilization of | | | | cholesterol, |
| | | | and | | glucose | | | | LDL, and |
| | | | increase | | Increases | | | | triglyceride |
| | | | HDL | | satiation and | | | | Helps |
| | | | | | suppresses | | | | increase |
| | | | | | appetite | | | | HDL |
| Vitamin B1 | Participate | Phaseolus | Reduce | Chitin | Reduce | | | | |
| Vitamin B2 | in | vulgaris | sugar | Natural fiber | fat | | | | |
| | protein | extract | breakdown | | absorption | | | | |
| | synthesis | Chlorogenic | and | | Reduce fat | | | | |
| | Help | acid | absorption | | absorption by | | | | |
| | increase | | Reduce | | intestine and | | | | |
| | basal | | body fats | | stomach by | | | | |
| | metabolic | | by 10.5% | | about 27% | | | | |
| | rate | | within 30 | | Increase | | | | |
| | | | days | | HDL | | | | |
| | | | Improve | | | | | | |
| | | | insulin | | | | | | |
| | | | resistance | | | | | | |
| | | | Suppress | | | | | | |
| | | | glucose | | | | | | |
| | | | absorption | | | | | | |
| | | | by | | | | | | |
| | | | intestine | | | | | | |
| | | | Help | | | | | | |
| | | | reduce | | | | | | |
| | | | cholesterol | | | | | | |
| | | | Promote | | | | | | |
| | | | fat burning | | | | | | |
| | | | Reduce | | | | | | |
| | | | fat | | | | | | |
| | | | absorption | | | | | | |
| | | | by | | | | | | |
| | | | intestinal | | | | | | |
| | | | tract | | | | | | |
| Nicotinic | | Cinnamon | Lowers | Raspberry | Increases fat | | | | |
| acid | | | after-meal | | burning about | | | | |
| | | | blood | | fivefold | | | | |
| | | | sugar by | | | | | | |
| | | | about 20% | | | | | | |
| | | | on average | | | | | | |
| Pantothenic | | Bitter | Lowers | | | | | | |
| acid | | gourd | blood | | | | | | |
| | | | sugar by | | | | | | |
| | | | about 25% | | | | | | |
| Vitamin B6 | | | | | | | | | |
| Vitamin | | | | | | | | | |
| B12 | | | | | | | | | |

Thus, after the analysis server unit 40, which is connected to the user input unit 10, the body constitution analysis data unit 20, and the functional food data unit 30, retrieves the personal data 100, the personal genetic data 101, and the obesity-associated body constitution data 21 and performs data comparison, exchange, and integration, the personalized functional food formula report 41 is obtained. This report not only gives the user an idea of the functional food that best meets the user's needs, but also provides the appropriately prepared functional food ingredient type data 411 and functional food ingredient quantity data 412, allowing the user to carry out precise body weight control and achieve the ideal body weight. Upon outputting the personalized functional food formula report 41, the analysis server unit 40 stores the report into the analysis result storage unit 50, too, so that the user may at a later time rapidly obtain the old data through the user input unit 10 for reference by the user him/herself or by the food provider entrusted with the preparation of the functional food.

What is claimed is:

1. A functional food formula analysis system for personalized body weight management, comprising a user input unit, a body constitution analysis data unit, a functional food data unit, an analysis server unit, and an analysis result storage unit, wherein:
the user input unit is connected to the analysis server unit and is configured for inputting at least one entry of personal data or personal genetic data;
the body constitution analysis data unit is connected to the analysis server unit and is configured for analyzing the personal data or the personal genetic data so as to obtain a user's obesity-associated body constitution data, and for sending the obesity-associated body constitution data to the analysis server unit;
the functional food data unit is connected to the analysis server unit and is configured for analyzing the personal data and the obesity-associated body constitution data so as to obtain a personalized functional food formula, and for sending the personalized functional food formula to the analysis server unit;
the analysis server unit is connected to the user input unit, the body constitution analysis data unit, and the functional food data unit and is configured for retrieving, and performing data comparison, exchange, and integration on, the personal data, the personal genetic data, and the obesity-associated body constitution data, and for outputting a personalized functional food formula report; and
the analysis result storage unit is connected to the analysis server unit and is configured for storing the personalized functional food formula report.

2. The functional food formula analysis system of claim 1, wherein the personal data include a name, an identification card number, a gender, a body height, and a body weight.

3. The functional food formula analysis system of claim 1, wherein the personal genetic data include an identification card number, β2-adrenergic receptor-based obesity gene data, β3-adrenergic receptor-based obesity gene data, uncoupling protein-based obesity gene data, and melanocortin-4 receptor-based obesity gene data.

4. The functional food formula analysis system of claim 1, wherein the obesity-associated body constitution data include an identification card number, a gender, an obesity gene, a test result, and a function rating.

5. The functional food formula analysis system of claim 1, wherein the personalized functional food formula report includes personal body constitution data, functional food ingredient type data, and functional food ingredient quantity data.

6. The functional food formula analysis system of claim 1, wherein the personalized functional food formula includes a corresponding formula ingredient and an auxiliary ingredient.

7. The functional food formula analysis system of claim 1, wherein the functional food formula comprises an ingredient selected from the group consisting of leucine, isoleucine, valine, vitamin B1, vitamin B2, nicotinic acid, pantothenic acid, vitamin B6, vitamin B12, African mango extract, gymnemic acid, chromium, Phaseolus vulgaris extract, chlorogenic acid, cinnamon, bitter gourd, citric acid monohydrate, caffeine, capsicin, chitin, natural fiber, raspberry, saffron stigma extract, potato extract, theanine, citrus bioflavonoid, and cocoa bean extract.

8. The functional food formula analysis system of claim 4, wherein the obesity gene comprises a β2-adrenergic receptor-encoding gene, a β3-adrenergic receptor-encoding gene, an uncoupling protein-encoding gene, and a melanocortin-4 receptor-encoding gene.
